(19) United States
(12) Patent Application Publication
(10) Pub. No.: US 2016/0138337 A1
(43) Pub. Date: May 19, 2016

(54) Window Well Egress Apparatus

(71) Applicant: Daniel K. Snarr, Tooele, UT (US)

(72) Inventor: Daniel K. Snarr, Tooele, UT (US)

(21) Appl. No.: 14/945,250

(22) Filed: Nov. 18, 2015

Related U.S. Application Data
(60) Provisional application No. 62/081,392, filed on Nov. 18, 2014.

(51) Int. Cl. E06C 1/34; E05F 1/08; E05F 1/16; E05F 1/02; E04F 17/06; E06C 7/12

(52) U.S. Cl. CPC E06C 1/34; E04F 17/06; E06C 7/12; E05F 1/16; E05F 1/025; E05F 1/08

(57) ABSTRACT

This is a system that allows a small child to escape from a window well using a ladder and a window well cover. The ladder extends from the bottom of the window well cover and has a trigger that when activated slides the ladder and releases a trap door in the window well cover, thus allowing a person to climb the ladder and escape through the cover.

### CROSS-REFERENCE TO RELATED APPLICATIONS

This application claims the benefit of U.S. Provisional Patent Application Ser. No. 62/081,392, filed Nov. 18, 2014, and entitled the “Window Well Egress Apparatus.” The disclosure of the application to which the present application claims priority is incorporated by reference.

### TECHNICAL FIELD

The present disclosure relates generally to a cover for a window well and an egress ladder. More particularly, the disclosure relates to a window well cover that combines a ladder and mechanically driven systems to create an opening in the window well cover to allow for egress.

### BACKGROUND

Modern building code dictates that every habitable bedroom in a dwelling must have an egress window. While the primarily objective is to allow occupants of the dwelling to escape in the event of an emergency, it also creates an access point for emergency workers to easily enter the dwelling. Furthermore, a window improves the quality of living by providing ample sunlight and ventilation in the basement living areas.

As dwellings have expanded and basements have become more prevalent, homebuilders are incorporating more basement bedrooms into their designs. To maximize subsurface living space while also conforming to the building code, builders must include basement windows. Consequently, window wells must be constructed around the windows to create an opening and retain the surrounding soil.

Although the need for window wells is predicated on building safety, their presence also creates an inherent safety and security hazard. First, in essence a window well is an exposed “well” that an individual can fall into. This safety concern is of particular relevance for small children. Second, window wells and subsurface windows create an easy and relatively concealed access point for intruders to enter the dwelling.

In an effort to combat both the safety and security concerns of window wells, numerous inventors have created window well covers. These covers greatly curb the safety and security risk of window wells, but the negative tradeoff is they also impede emergency egress.

This compromise is evident in U.S. Pat. No. 3,046,613 of a window well cover. The apparatus utilizes a perforated sheet of metal to cover the window well opening. Although it eliminates the risk of an individual falling in the well, the weight of the metal cover could prevent its removal in an emergency.

U.S. Pat. No.8,091,292 attempted to improve upon this rudimentary design by incorporating a pivoting hinge mechanism and a pneumatic actuator to aid in the lifting process. Despite its advantages in helping some people to remove the window well cover, the apparatus provides little benefit to children and smaller individual who cannot reach the cover from within the window well.

In view of the multiple deficiencies of existing apparatuses, there remains an unsatisfied need for a window well cover that addresses both safety and security concerns of an exposed well, while also promoting easy egress for individuals of all sizes.

### BRIEF SUMMARY

The general purpose of the systems and methods disclosed herein is to provide an improved window well cover that addresses the safety and security concerns of an exposed well, while also promoting easy egress from within the well. Specifically, the window well egress apparatus will aid smaller individuals who would otherwise be unable to remove the well cover. The overall apparatus contains two major components, a cover grate with a selectively movable subsection and a ladder system that allows a user to access and egress through the opening created by the selectively movable subsection in the grate. This apparatus is designed to work in conjunction with a variety of existing window well structures, but it could also be included in conjunction with a new window well structure.

In one non-limiting embodiment, the apparatus comprises a window well cover grate with a subsection that can slide independently of the remaining gate. A mechanical system is also included to exert a force upon the sliding subsection, operable to slide the subsection linearly and create an opening in the cover grate. The mechanical system comprises a cable, pulley and weight, which work collectively to apply an opening force on the subsection of the grate.

A ladder system is also included in the embodiment and serves two purposes. First it allow smaller individual to exit the well, and second it interlocks with the sliding subsection of the grate. The ladder system comprises a ladder frame, a sliding ladder section, and a means of connecting the ladder section to the ladder frame. The sliding ladder section further includes at least one catch peg that interlocks with the sliding subsection of the grate to restrict movement. A mechanical system is utilized to maintain contact between the sliding section of the grate, and the catch pegs attached to the sliding section of the ladder. The mechanical system comprises a pulley, a cable and weight to exert a force upon the sliding section of the ladder.

In one alternative embodiment, the ladder system includes several members that interface with the side wall of the window well. These members provide a uniform base for the ladder frame and maintain the upright position of the ladder. Furthermore, the members allow the cover grate to be removed independently of the ladder system.

In an emergency, an individual merely applies weight to or adjacent to the sliding ladder section. This applied weight exceeds the force applied by the mechanical system and the ladder descends down the ladder frame. This movement causes the catch pegs to disconnect, which allows for movement of the sliding grate subsection and creates an opening.

In another non-limiting embodiment, the apparatus comprises a window well cover grate with a subsection that can slide independently of the remaining gate. A mechanical system is also included to exert a force upon the sliding subsection, operable to slide the subsection linearly and create an opening in the cover grate. The mechanical system comprises one or more springs, which work collectively to apply an opening force on the subsection of the grate.

A ladder system is also included in the embodiment and serves two purposes. First it allow smaller individual to egress and exit the well, and second it also interlocks with the sliding subsection of the grate. The ladder system comprises a ladder frame, a sliding ladder section, and a means of connecting the ladder section to the ladder frame. The sliding ladder section further includes at least one catch peg that interlocks with the sliding subsection of the grate to restrict movement. A mechanical system is utilized to maintain contact between the sliding section of the grate, and the catch pegs attached to the sliding section of the ladder. The mechanical system comprises one or more springs to exert a force upon the sliding section of the ladder.

In one embodiment, the ladder system includes several members that interface with the side wall of the window well. These members provide a uniform base for the ladder frame and maintain the upright position of the ladder. Furthermore, the members allow the cover grate to be removed independently of the ladder system.

In an emergency, an individual merely applies weight to or adjacent to the sliding ladder section. This applied weight exceeds the force applied by the mechanical system and the ladder descends down the ladder frame. This movement causes the catch pegs to disconnect, which allows movement of the sliding grate subsection and creates an opening.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment, but may refer to every embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The features and advantages of the present invention will become more fully apparent from the following description and appended claims, or may be learned by the practice of the invention as set forth hereinafter.

### BRIEF DESCRIPTION OF THE DRAWINGS

In order to describe the manner in which the advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A shows a detailed plan view of the window well cover with a sliding subsection. The drawing also illustrates a pulley, cable and weight that are used to exert a force on the sliding section of the grate.

FIG. 1B shows a detailed side view of the window well cover and ladder mechanism. The drawing also illustrates a pulley, cable and weight that are used to exert a force on the sliding section of the ladder.

FIG. 1C shows a detailed front perspective view of the ladder mechanism. The figure also illustrates a pulley, cable and weight that are used to exert a force on the sliding section of the ladder.

FIG. 2 shows an embodiment of the invention where several members are used to maintain the ladder in an upright position. The figure also illustrates the pulley, cable and weight that are used to exert a force on the sliding section of the ladder.

FIG. 3A shows a detailed plan view of the window well cover with a sliding subsection. The drawing also illustrates a spring that is used to exert a force on the sliding section of the grate.

FIG. 3B shows a detailed side view of the window well cover and ladder mechanism. The figure also illustrates a spring that is used to exert a force on the sliding section of the ladder.

FIG. 3C shows a detailed front perspective view of the ladder mechanism. The drawing also illustrates a spring that is used to exert a force on the sliding section of the ladder.

FIG. 4 shows an embodiment of the invention where several members are used to maintain the ladder in an upright position. The figure also illustrates the springs that are used to exert a force on the sliding section of the ladder.

FIG. 5 shows an alternative embodiment of an egress ladder.

FIG. 5A shows the main grate with a push block.

FIG. 5B shows the lift lever with the fulcrum.

FIG. 5C shows the ladder frame with the sliding section of the ladder.

### DETAILED DESCRIPTION OF THE INVENTION

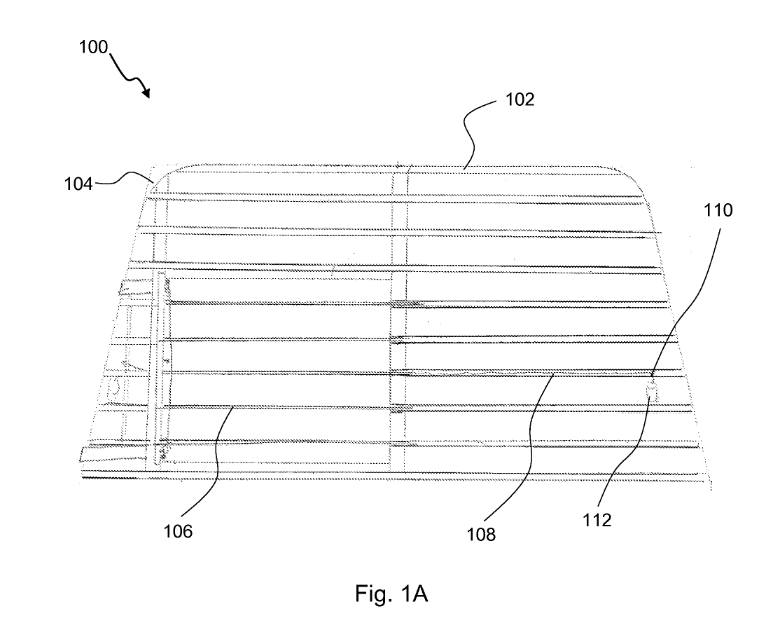

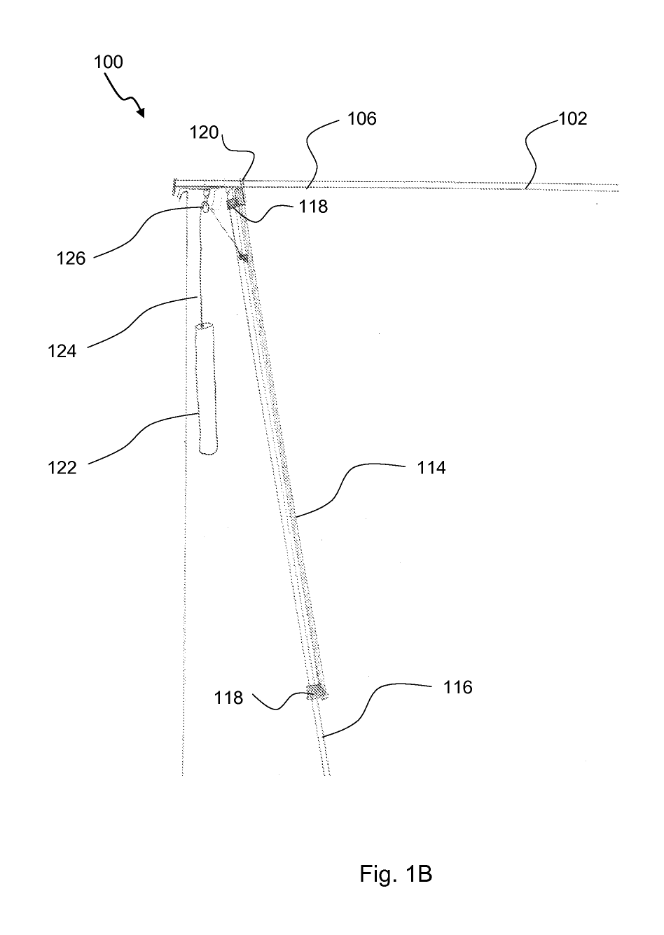

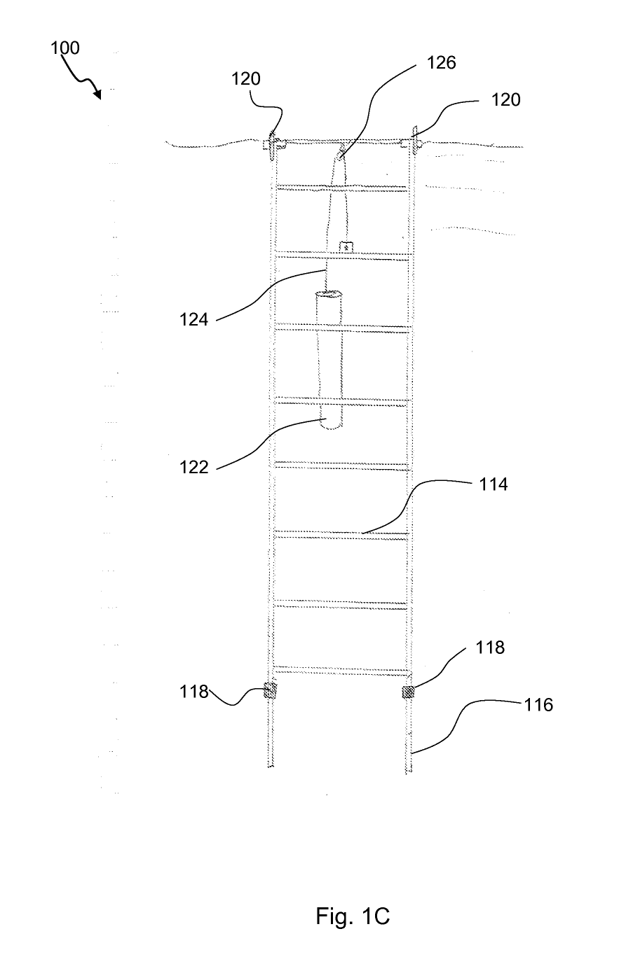

The present embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed descriptions of the embodiments of the apparatus, as represented in FIGS. 1A-C, 2, 3A-C and 4-5C are not intended to limit the scope of the invention, as claimed, but is merely representative of present embodiments of the invention.

In general, the figures disclose an invention that provides a window well cover egress apparatus that can be used to safely cover an exposed window well, while also providing for a safe and easy egress from within the well. The window well egress apparatus of the disclosed invention is especially beneficial for small individuals, who otherwise would be unable to reach the window well cover from within the well. Larger individuals may simply lift and remove the entire cover grate and use the ladder independently.

In the following description, numerous references will be made to windows, window wells and window well structures, but these items are not shown in detail in the figures. However, it should be understood that one of ordinary skill in the art and in possession of this disclosure, would readily understand how the present invention and existing windows, window wells and window wells structures can be incorporated.

Detailed references will now be made to the preferred embodiments of the present invention, examples of which are illustrated in FIGS. 1A-C. FIGS. 1A-C illustrate various views of a window well egress apparatus 100 in accordance with one or more embodiments of the invention.

A plan view of the overall apparatus is shown in FIG. 1A. The apparatus 100 of FIG. 1A includes a main grate 102 of no particular size or shape, but is fabricated to completely cover and rest upon a window well structure 104. Within the main grate 102, is a subsection 106 that can move independently of the remaining grate 102. Generally, the subsection may comprise a sliding subsection 106 with an open and closed position. Alternative embodiments may comprise a swinging door, a trap door, a lift and slide door, folding door, a roll-away door, or any other mechanism that would allow the subsection to open to allow egress through the main grate 102. Accordingly, when the sliding section 106 is in the closed position it works in conjunction with the main grate 102 to create a uniform window well cover. Conversely, when the sliding section 106 is in the open position, an individual may exit the grate through the created opening.

The movement of the sliding section 106 is driven by a potential energy source. In some embodiments a cable 108, a pulley 110 and a weight 112. Collectively, these items are assembled to exert an opening force on the sliding section 106. Generally, under the influence of gravity the weight will descend and exert a force on the cable 108. The pulley 110 translates the vertical force of the descending weight into a horizontal force and pulls the sliding section 106 open. Under the influence of the weight, the sliding section's 106 default position is open, and energy must be exerted to close the sliding section 106. In alternative embodiments the potential source may comprise electrical energy such as a battery or power from the grid may be used to activate and actuate the subsection.

As shown in FIG. 1B-1C, the invention also discloses a ladder system that provides a means for individuals to exit the window well. The ladder system includes a sliding ladder section 114 that is attached to a ladder frame 116 using slide brackets 118. In addition to its functional use in assisting egress, the ladder also serves as a mechanism to restrict the movement of the sliding section 106, and as a trigger to release the sliding section 106 to create an opening. The sliding ladder section 114 has catch pegs 120 that interlock with the sliding section of the grate 106. While the catch pegs 120 and sliding section 106 are interlocked, the sliding section of the grate 106 remains in the closed position.

The ladder system also utilizes a weight 122, a cable 124 and a pulley 126 to cause an interaction with the sliding section of the grate 106. Generally, under the influence of gravity the weight 122 will descend and exert a force on the cable 124. The pulley 126 translates the downward vertical force of the descending weight into an upward vertical force and pulls the sliding section of the ladder 114 upward. Under the influence of the weight 122, the ladder sliding section's 114 default position is up which creates contact with the sliding section of the grate 106.

However, when an individual exerts weight on or near the sliding section of the ladder 114, the force exceeds the force of the weight 122 holding the ladder up and the ladder section 114 slides downward on the ladder frame 116. As the ladder section 114 moves downward, the catch pegs 120 lose contact with the sliding section of the grate 106. Without the pegs to restrict the movement of the sliding section of the grate 106, the weight drops 112 and the sliding section of the grate 106 opens.

The ladder system is not attached to the main grate so larger individuals may simply remove the entire main grate 102, and use the ladder 114 to exit the well.

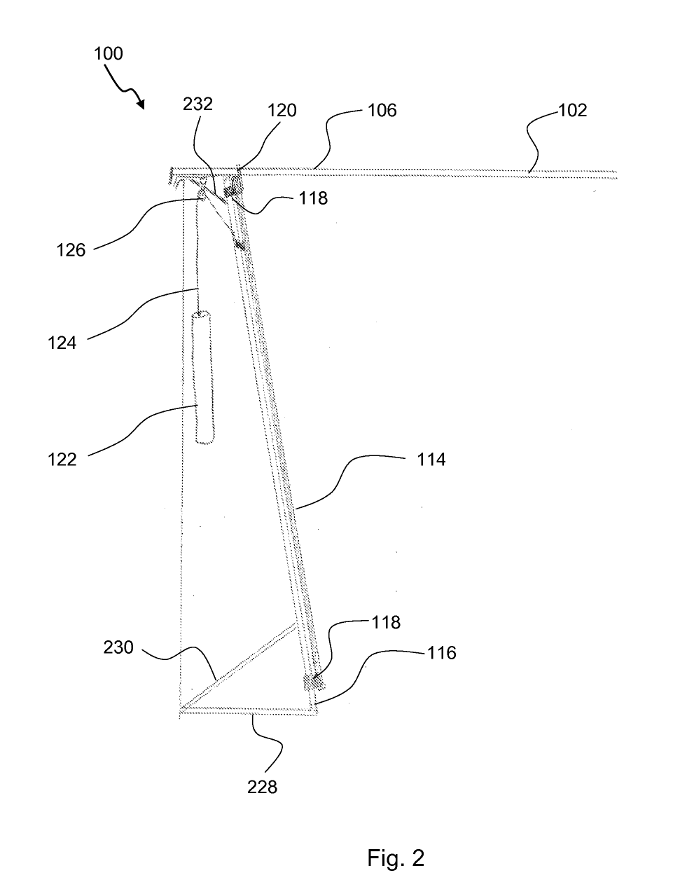

In one embodiment, the ladder system further comprises one or more members to provide stability and maintain the ladder system in an upright position. These members are depicted in conjunction with the ladder system in FIG. 2. One or more horizontal base members 228 are attached near the bottom of the ladder frame 116. The horizontal base members 228 provide a uniform contact surface with the ground, and may interface with the window well side wall. A sloping member 230 is also included to improve the rigidity between the ladder frame 116 and the horizontal base member 228. Finally, an additional sloping member 232 is attached to the ladder frame 116 near the top of the window well wall. The sloping member 232 maintains the horizontal position of the ladder frame 116, and allows for the ladder frame 116 to maintain its position if the cover grate 102 is removed. The base member 228, bottom sloping member 230, and top sloping member 232 work in conjunction to maintain the ladder at an angle between 45 and 90 degrees with the ground surface.

In another embodiment, the apparatus utilizes springs to apply the requisite forces. A plan view of the overall apparatus is shown in FIG. 2A. The apparatus 300 of FIG. 2A includes a main grate 302 of no particular size or shape, but is fabricated to completely cover and rest upon a window well structure 304. Within the main grate 302, is a sliding section 306 that can move independently of the remaining grate 302. Generally, this sliding section 306 has an open and closed position. Accordingly, when the sliding section 306 is in the closed position in works in conjunction with the main grate 302 to create a uniform window well cover. Conversely, when the sliding section 306 is in the open position, an individual may exit the grate through the created opening.

The movement of the sliding section 306 is driven by one or more mechanical springs 308. Collectively, these springs are assembled to exert an opening force on the sliding section 306. Generally, under the influence of the springs 308 the sliding section's 306 default position is open and energy must be exerted to close the sliding section 306. The springs may apply a tension, compression, or torsion force to open the sliding section of the grate 306.

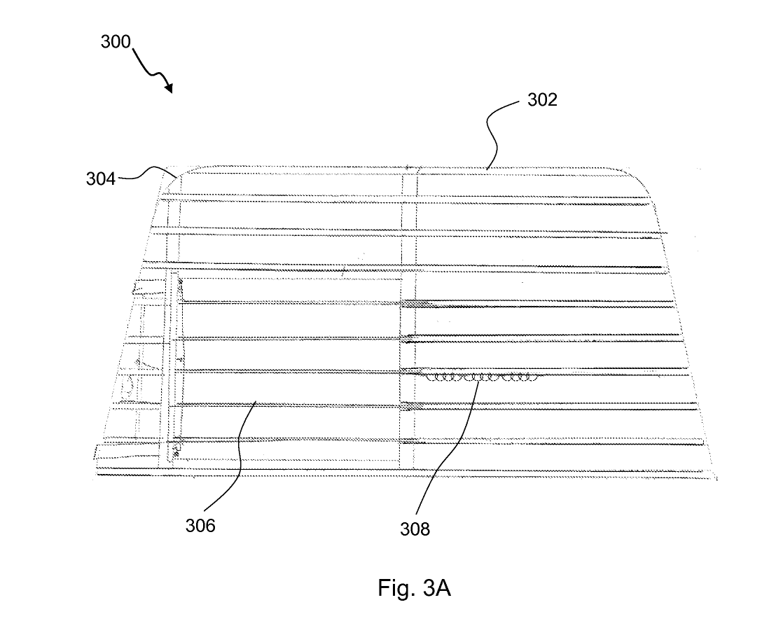

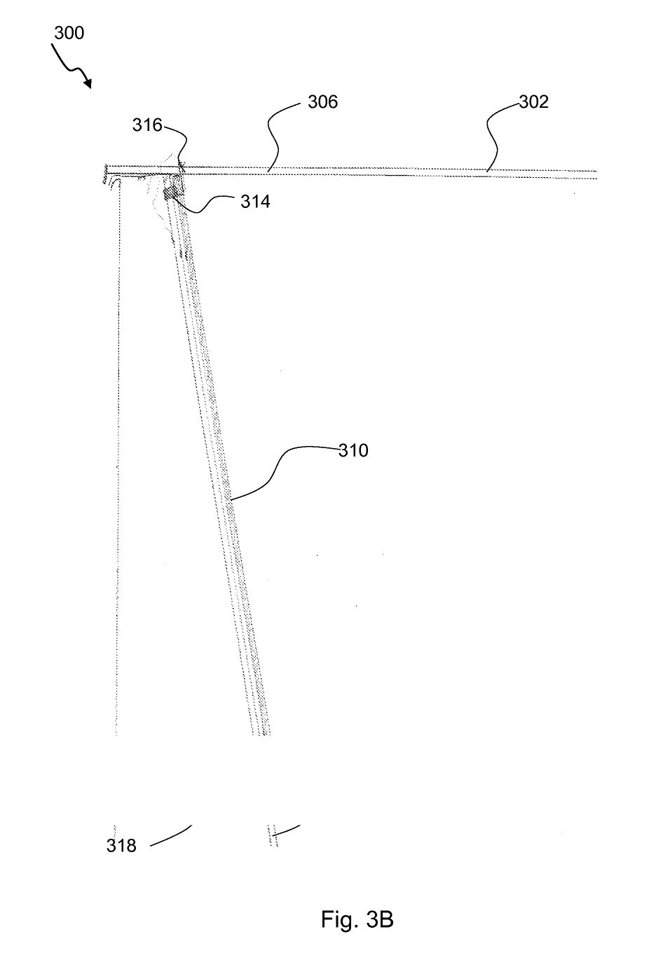

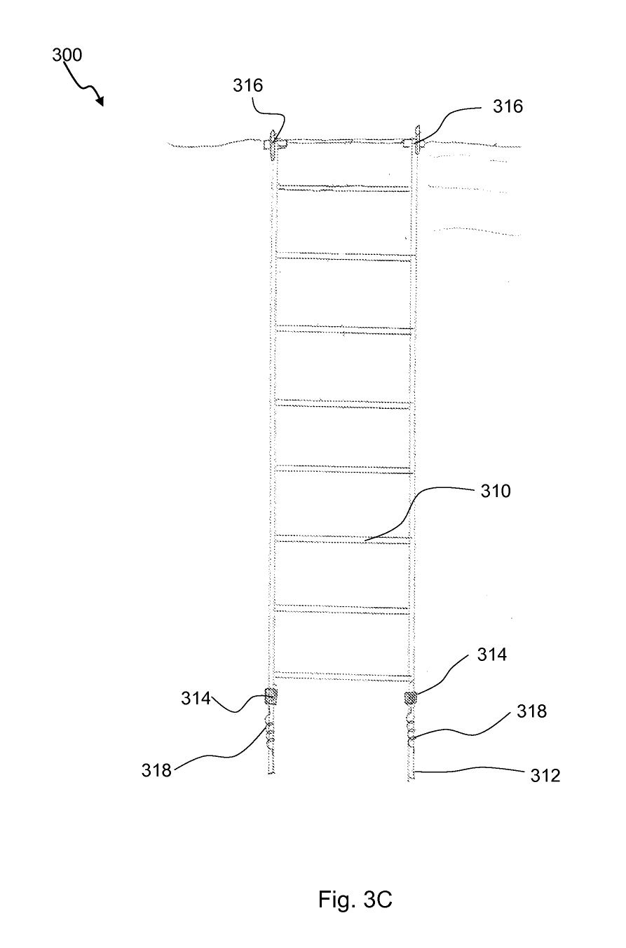

As shown in FIG. 3B-3C, the invention also discloses a ladder system that provides a means for individuals to exit the window well. The ladder system includes a sliding ladder section 310 that is attached to a ladder frame 312 using slide brackets 314. In addition to its functional use in assisting egress, the ladder also serves as a restraint to the sliding section 306 and a trigger to release the sliding section 306 to create an opening. The sliding ladder section 310 has catch pegs 316 that interlock with the sliding section of the grate 306. While the catch pegs 316 and sliding section 306 are interlocked, the sliding section 306 of the grate remains in the closed position.

The ladder system utilizes one of more springs 318 to cause interaction with the sliding section of the grate 306. Generally, under the influence of the springs 318, the ladder sliding section's 310 default position is up which creates contact with the sliding section of the grate 306.

However, when an individual exerts weight on or near the sliding section of the ladder 310. The force exceeds the force of the springs 318 forcing the ladder section 310 up and the ladder sections 310 slides downward on the ladder frame 312. As the ladder section 310 moves downward, the catch pegs 316 lose contact with the sliding section of the grate 306. Without the pegs 316 to restrict the movement of the sliding section of the grate 306, the springs 308 cause the sliding section of the grate 306 to open.

The ladder system is not attached to the main grate so larger individuals may simply remove the entire main grate 302, and use the ladder 310 to exit the well.

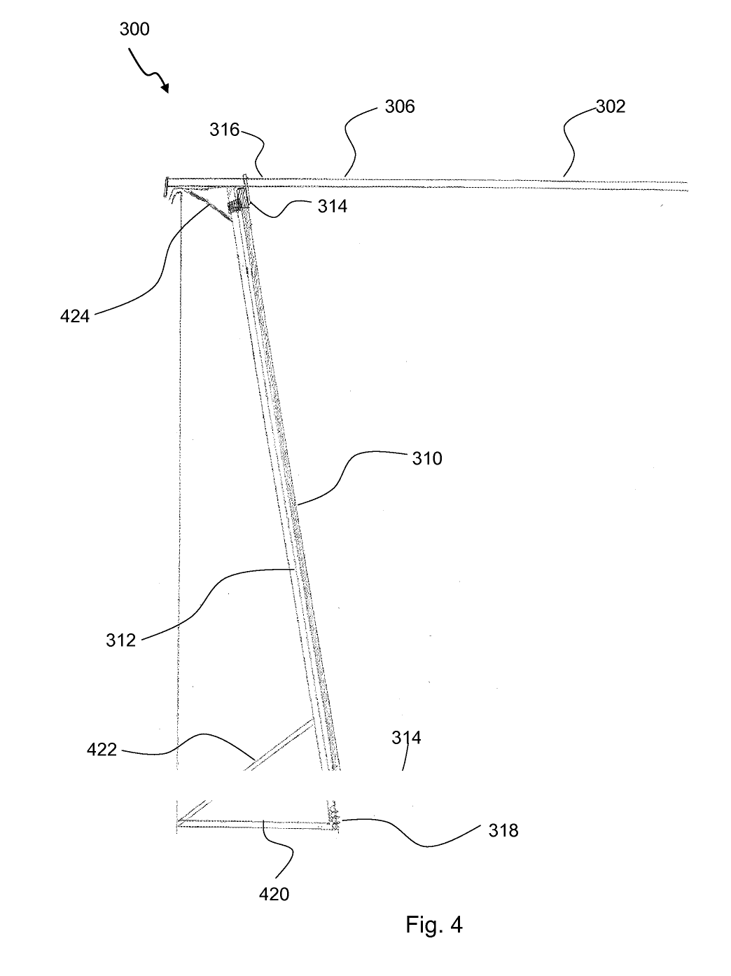

In one embodiment, the ladder system further comprises one or more members to provide stability and maintain the ladder system in an upright position. These members are depicted in conjunction with the ladder system in FIG. 4. One or more horizontal base members 420 are attached near the bottom of the ladder frame 312. The horizontal base members 420 provide a uniform contact surface with the ground, and may interface with the window well side wall. A sloping member 422 is also included to improve the rigidity between the ladder frame 312 and the horizontal base member 420. Finally, an additional sloping member 424 is attached to the ladder frame 312 near the top of the window well wall. The sloping member 420 maintains the horizontal position of the ladder frame 312, and allows for the ladder frame 312 to maintain its position if the cover grate 302 is removed. The base member 420, bottom sloping member 422, and top sloping member 424 work in conjunction to maintain the ladder at an angle between 45 and 90 degrees with the ground surface.

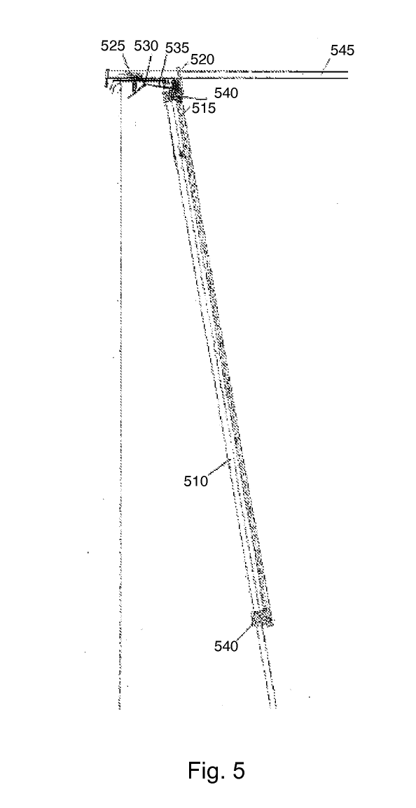

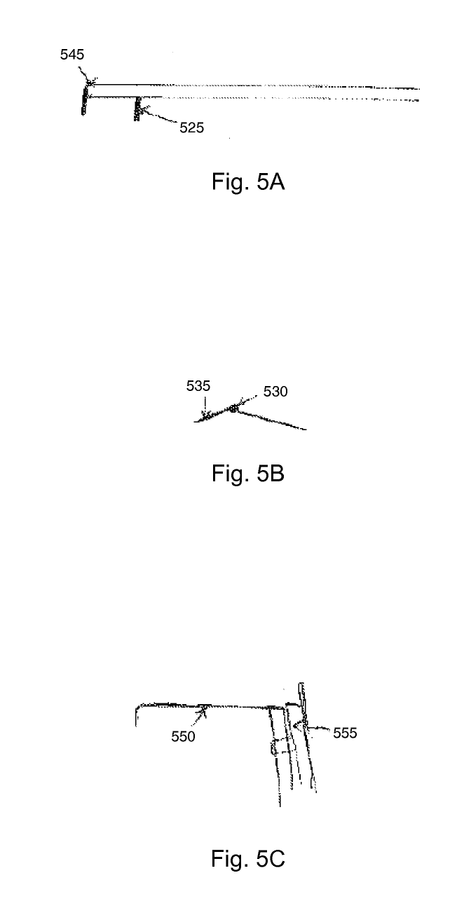

FIGS. 5-5C disclose an alternative embodiment of the window well egress apparatus 500. In this embodiment the ladder frame 510 extends from the main grate 545. A sliding section of the ladder 515 is integrated into the ladder frame 510 to permit the ladder to actuate the catching mechanism when the ladder is weighted. In this embodiment the weight of the grate 545 replaces the weight 112 and cable 108 of other embodiments. The main grate 545 further comprises a push block 525 and is integrated into the main grate 545. When the main grate 545 is placed upon the ladder apparatus 510, 515, the fulcrum lever 530 activates the lift lever 535 and lifts the sliding section of the ladder 515 through the slide brackets 535 engaging the catch pegs 520. FIG. 5C shows the attachment point for the fulcrum 550 as well as the contact point for the lever 555.

In closing, it is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

1. A window well egress apparatus comprising:
a window well cover with a selectively movable subsection that upon activation moves to create an aperture in the cover; and
a mechanical system comprising a ladder connected to the cover, the ladder further comprising a trigger wherein the upon activation actuates the trigger causing the subsection to move and create an aperture.

2. The apparatus of claim 1, wherein the mechanical system comprises a potential energy vehicle which upon activation actuates the subsection.

3. The apparatus of claim 2, wherein the mechanical system comprises at least one pulley, cable and weight to exert a force upon the sliding subsection of the grate.

4. The apparatus of claim 1, wherein the mechanical system comprises one or more springs to exert a force upon the sliding subsection of the grate.

5. The apparatus of claim 1, wherein the ladder further comprises a ladder frame, a sliding ladder section, and wherein the ladder section is connected to the ladder frame.

6. The apparatus of claim 5, wherein the sliding ladder section includes at least one catch peg that interlocks with the subsection of the grate to restrict movement, and wherein the application of weight to or adjacent to the sliding ladder section causes the catch pegs to disconnect, which allows for movement of the sliding grate subsection.

7. The apparatus of claim 6, wherein a mechanical system is utilized to maintain contact between the sliding section of the grate, and the catch pegs attached to the sliding section of the ladder.

8. The apparatus of claim 7, wherein the mechanical system used to maintain contact between catch pegs and sliding section of the grate utilizes gravity.

9. The apparatus of claim 8, wherein the mechanical system comprises at least one pulley, cable and weight to exert a force upon the sliding section of the ladder.

10. The apparatus of claim 7, wherein the mechanical system comprises one or more springs to maintain contact between catch pegs and sliding section of the grate.

11. The apparatus of claim 6, wherein one or more members are connected to the ladder frame to create a ladder base and interface with the window well wall; and wherein the members collectively allow the ladder frame to remain in an upright position.

12. A window well egress apparatus comprising:
a window well cover grate with an independently sliding subsection;
a mechanical system to exert a force upon the sliding subsection, operable to slide the subsection linearly and create an opening in the cover grate;
at least one linear member to form a ladder frame;
a sliding ladder section that is attached to the ladder frame using slide brackets;
a mechanical device to exert a force upon the ladder section, operable to slide the ladder section linearly upward.

13. The apparatus of claim 6, wherein one or more members are connected to the ladder frame to create a ladder base and interface with the window well wall; and wherein the members collectively allow the ladder frame to remain in an upright position.

14. The apparatus of claim 12, wherein the mechanical systems used to exert a force upon the sliding subsection of the grate and sliding section of the ladder utilizes gravity.

15. The apparatus of claim 14, wherein the mechanical systems comprise at least one pulley, cable and weight to exert a force upon the sliding subsection of the grate and the sliding ladder section.

16. The apparatus of claim 12, wherein the mechanical systems comprises one or more springs to exert a force upon the sliding subsection of the grate and the sliding ladder section.

17. The apparatus of claim 12, wherein the sliding ladder section includes at least one catch peg that interlocks with the sliding subsection of the grate to restrict movement, and wherein the application of weight to or adjacent to the sliding ladder section causes the catch pegs to disconnect, which allows for movement of the sliding grate subsection.

18. A window well egress apparatus comprising:
a window well cover grate with an independently sliding subsection;
a mechanical system to exert a force upon the sliding subsection, operable to slide the subsection linearly and create an opening in the cover grate;
at least one linear member to form a ladder frame;
a sliding ladder section that is attached to the ladder frame using slide brackets;
a mechanical device to exert a force upon the ladder section, operable to slide the ladder section linearly upward;
wherein the sliding ladder section includes at least one catch peg that interlocks with the sliding subsection of the grate to restrict movement, and wherein the application of weight to or adjacent to the sliding ladder section causes the catch pegs to disconnect, which allows for movement of the sliding grate subsection.

19. The apparatus of claim 18, wherein one or more members are connected to the ladder frame to create a ladder base and interface with the window well wall; and wherein the members collectively allow the ladder frame to remain in an upright position.

20. The apparatus of claim 18, wherein the mechanical systems used to exert a force upon the sliding subsection of the grate and sliding section of the ladder utilizes gravity.

21. The apparatus of claim 20, wherein the mechanical systems comprise at least one pulley, cable and weight to exert a force upon the sliding subsection of the grate and the sliding ladder section.

22. The apparatus of claim 18, wherein the mechanical systems comprises one or more springs to exert a force upon the sliding subsection of the grate and the sliding ladder section.
